(19) United States
(12) Patent Application Publication
(10) Pub. No.: US 2009/0217533 A1
(43) Pub. Date: Sep. 3, 2009

(54) Folding knife with turning device on knife handle

(76) Inventor: Chih-Chen Kao, Taoyuan City (TW)

Correspondence Address: BACON & THOMAS, PLLC, 625 SLATERS LANE, FOURTH FLOOR, ALEXANDRIA, VA, 22314-1176, US

(21) Appl. No.: 12/155,594

(22) Filed: Jun. 6, 2008

Related U.S. Application Data
(63) Continuation of application No. 12/071,951, filed on Feb. 28, 2008.

(51) Int. Cl. B26B 1/02; B26B 11/00

(52) U.S. Cl. 30/159

(57) ABSTRACT

The present invention discloses a folding knife, which includes a knife handle having a slot; a blade pivotally coupled to the knife handle and turnable into or out from the knife handle; a resilient device fixed to the knife handle and extended to a position proximate to the pivotal connecting position, such that when the blade is stored completely into the knife handle, the resilient device produces a torque to turn the blade into the knife handle, and when the blade is turned to a predetermined angle out of the knife handle, the resilient device produces a torque to turn the blade out from the knife handle; and a turning device, pivotally coupled to the knife handle and having a protruding pillar passed through the slot for securing or releasing the blade as required.

This is a continuation application of U.S. Ser. No. 12/071,951, filed on Feb. 28, 2008, entitled “FOLDING KNIFE WITH TURNING DEVICE ON KNIFE HANDLE”.

### FIELD OF THE INVENTION

The present invention relates to a folding knife, and more particularly to a folding knife with a turning device installed at a handle of the knife, so that a user can simply use one hand to turn the turning device to pop a blade out of the knife handle automatically.

### BACKGROUND OF THE INVENTION

In general, a traditional folding knife comes with a knife handle and a blade, wherein an end of the blade is pivotally coupled to an end of the knife handle, such that the blade can be pivoted with respect to its pivotal connecting position and turned out from the knife handle or stored into the knife handle, as required. If a user wants to use the folding knife, the user holds the knife handle by one hand, and pulls the blade by another hand to turn the blade out from the knife handle. Since users turn the blade out from the knife handle by one hand, the folding knives of this sort are inconvenient to use and unable to deal with emergency situations. For example, if a travel explorer's hand is tangled and stabbed by thistles and thorns, the travel explorer will be unable to cut the thistles and thorns by the folding knife quickly to extricate from danger immediately.

To overcome the shortcomings of the aforementioned conventional folding knife, the inventor of the present invention had developed a folding knife with a turning device as shown in FIGS. 1 and 2, and the folding knife 1 includes a knife handle 11, a blade 12, a resilient device 13 and a turning device 14. An end of the blade 12 is pivotally coupled to the knife handle 11, so that the blade 12 can be turned along the pivotal connecting position into or out from the knife handle 11. An end of the resilient device 13 is fixed to a position proximate to another end of the knife handle 11, and another end of the resilient device 13 is extended to a pivotal connecting position of the knife handle 11 and the blade 12, such that when the blade 12 is stored completely into the knife handle 11, the resilient device 13 produces a torque to turn the blade 12 towards the inside of the knife handle 11 to securely store the blade 12 in the knife handle 11. If a force is exerted onto the blade 12 to turn the blade 12 to a predetermined angle out of the knife handle 11, the resilient device 13 will produce a torque to turn the blade 12 towards the outside of the knife handle 11, such that the blade 12 can pop out of the knife handle 11 automatically. The turning device 14 is pivotally coupled to a pivotal connecting position of the knife handle 11 and the blade 12 and installed in the knife handle 11, and an end of the turning device 14 is extended to the outside of the knife handle 11 and includes a turning portion 141 protruded from the end of the turning device 14 and provided for users to turn the blade 12, and another end of the turning device 14 includes a pushing portion 142, such that when the blade 12 is stored completely in the knife handle 11, the pushing portion 142 presses against the blade 12. If a user turns the turning portion 141, the turning device 14 will be turned to drive the pushing portion 142 to apply a force to the blade 12, such that the blade 12 is turned to the predetermined angle out from the knife handle 11, such that the user simply needs to turn an end of the turning device 14 to pop the blade 12 towards the outside of the knife handle 11 automatically. However, the turning portion 141 is protruded from the folding knife 1, and thus the folding knife 1 cannot be stored easily into any knife sheath, except the one with an appropriate size, and the appearance of the folding knife 1 cannot show an overall aesthetic look. Further, if the folding knife 1 is dropped accidentally, the turning portion 141 will probably hit the ground, and the blade 12 may pop out from the knife handle 11 automatically and collide with the ground or damage the blade 12 or injure the user or any other person nearby. In addition, if the user puts the folding knife 1 into a pocket and touches the turning portion 141 by accident, the blade 12 will pop out from the knife handle 11. In such case, the folding knife 1 not only cuts the clothes of the user, but may even pierce or cut the user. Obviously, the aforementioned folding knife 1 has the risk of jeopardizing the safety of the users.

Thus, it is an important subject of the present invention to design and manufacture a folding knife that can meet the safety requirements while maintaining the convenience of use.

### SUMMARY OF THE INVENTION

In view of the foregoing shortcomings of the prior art folding knife whose turning device may be touched by accident to pop the blade out from the knife handle automatically and jeopardize the user's safety, the inventor of the present invention based on years of experience in the related industry to conduct extensive researches and experiments, and finally developed a folding knife with a turning device installed on a knife handle in accordance with the present invention to overcome the shortcomings of the prior art.

It is a primary objective of the present invention to provide a folding knife with a turning device installed on a knife handle, and the folding knife comprises a knife handle, a blade, a resilient device and a turning device, wherein an end of the blade is pivotally coupled to an end of the knife handle, such that the blade can be turned along a pivotal connecting position into or out from the knife handle, and an end of the resilient device is fixed at a position proximate to another end of the knife handle, and another end of the resilient device is extended to a position proximate to a pivotal connecting position of the knife handle and the blade, so that the blade can be stored completely in the knife handle, and the resilient device produces a torque for turning the blade into the knife handle, and the blade can be securely stored in the knife handle. If a force is applied to the blade to turn the blade to a predetermined angle out from the knife handle, the resilient device will produce a torque to turn the blade out from the knife handle, so that the blade will pop out from the knife handle automatically. The knife handle has a slot disposed on a surface proximate to an end of the blade, and the turning device is pivotally coupled to a surface of the knife handle having the slot, and a spring is installed between the turning device and the knife handle, and the turning device has a protruding pillar disposed at a position proximate to a surface of the knife handle and passing through the slot. When the blade is stored completely in the knife handle, the protruding pillar presses against the blade, such that when a user turns the turning device, the protruding pillar applies a force to the blade to turn the blade to the predetermined angle out from the knife handle. Thus, the resilience of the spring resumes the turning device to its original position, so that the user can simply use one hand to turn the turning device to pop the blade out of the knife handle automatically. It is noteworthy to point out that when a user is in danger, the user can pop the blade automatically out from the knife handle quickly by one hand to save time greatly, and the user can use the folding knife immediately.

Another objective of the present invention is to design a concave surface on the exterior of the knife handle and proximate to an end of the blade, and the concave surface has a slot, and the turning device is pivotally coupled onto the concave surface by a spring, such that the turning device can be turned along its pivotal connecting position, and the turning device and the knife handle constitute the overall aesthetic appearance. Therefore, users can simply use a thumb to turn the turning device to pop the blade out from the knife handle automatically, so as to greatly enhance the overall aesthetic appearance of the folding knife and the convenience of use. Since the turning device and the knife handle constitute the whole folding knife, therefore the blade of the folding knife will not pop out automatically from the knife handle easily, not only preventing a possible damage to the blade, but also protecting the safety of the user effectively.

A further objective of the present invention is to design a force exertion pillar on the blade and at a position proximate to a side of a pivotal connecting position, and the turning device is pivotally coupled to the exterior of the knife handle and disposed proximate to a side of the force exertion pillar, such that if the turning device is turned, the turning device will be able to push the force exertion pillar and drive the blade to turn to a predetermined angle and pop the blade out from the knife handle, and thus users can operate the folding knife with one hand, so as to greatly improve the convenience of operating the folding knife.

To make it easier for our examiner to understand the objective, technical characteristics and effects of the present invention, preferred embodiments will be described with accompanying drawings as follows:

### BRIEF DESCRIPTION OF THE DRAWINGS

FIG. 1 is a cross-sectional view of a conventional folding knife having a turning device and being folded;

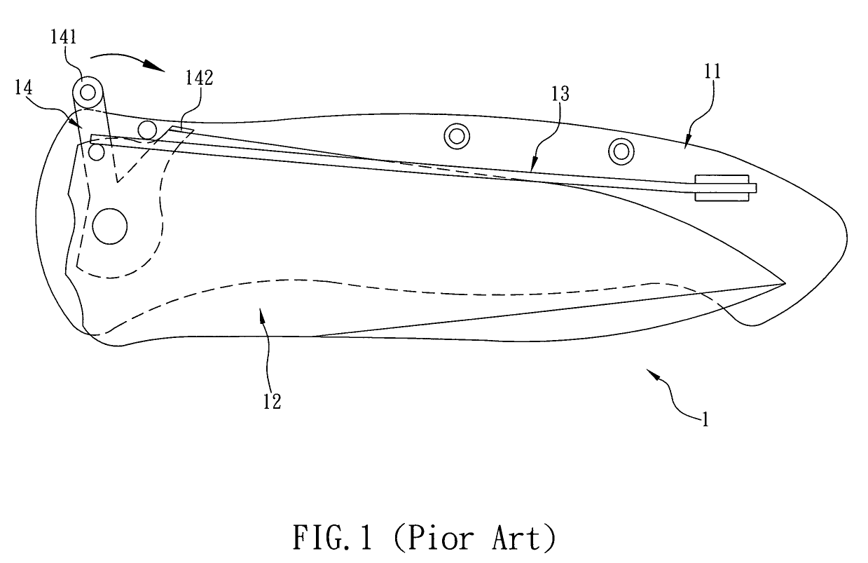

FIG. 2 is a schematic view of a turning device of a conventional folding knife;

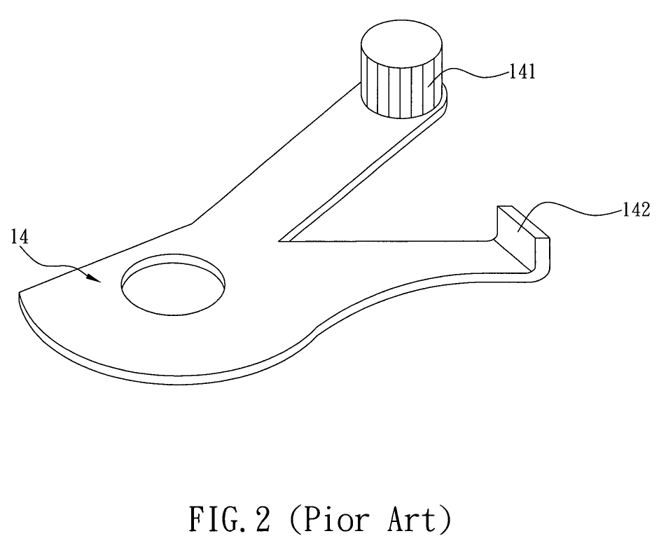

FIG. 3 is a perspective view of a folding knife being unfolded in accordance with a first preferred embodiment of the present invention;

FIG. 4 is a cross-sectional view of a folding knife being folded in accordance with a first preferred embodiment of the present invention;

FIG. 5 is a perspective view of a folding knife being unfolded in accordance with a second preferred embodiment of the present invention;

FIG. 6 is a cross-sectional view of a folding knife being folded in accordance with a second preferred embodiment of the present invention;

FIG. 7 is a schematic view of a folding knife being folded in accordance with a third preferred embodiment of the present invention; and

FIG. 8 is a perspective view of a folding knife in accordance with a third preferred embodiment of the present invention.

### DETAILED DESCRIPTION OF THE PREFERRED EMBODIMENTS

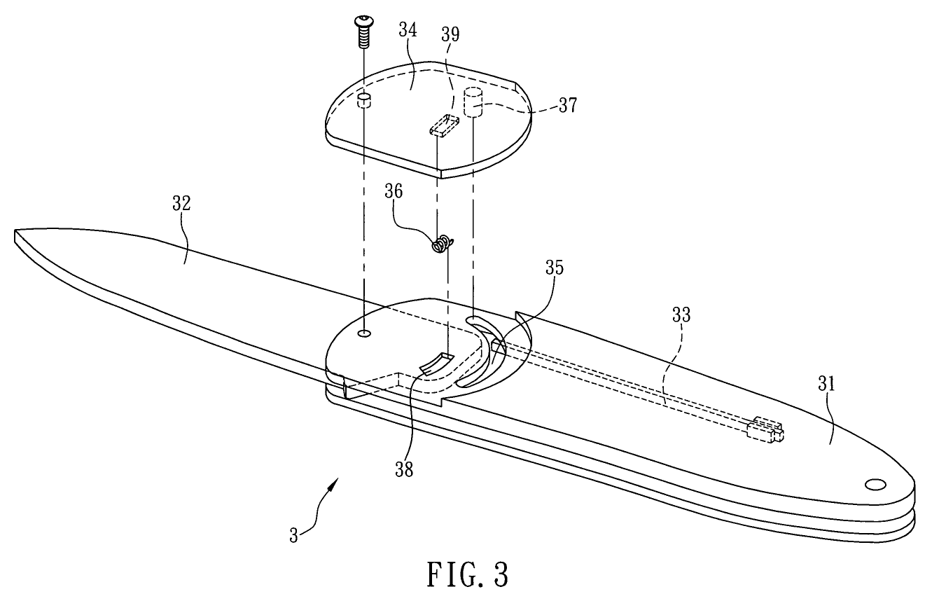

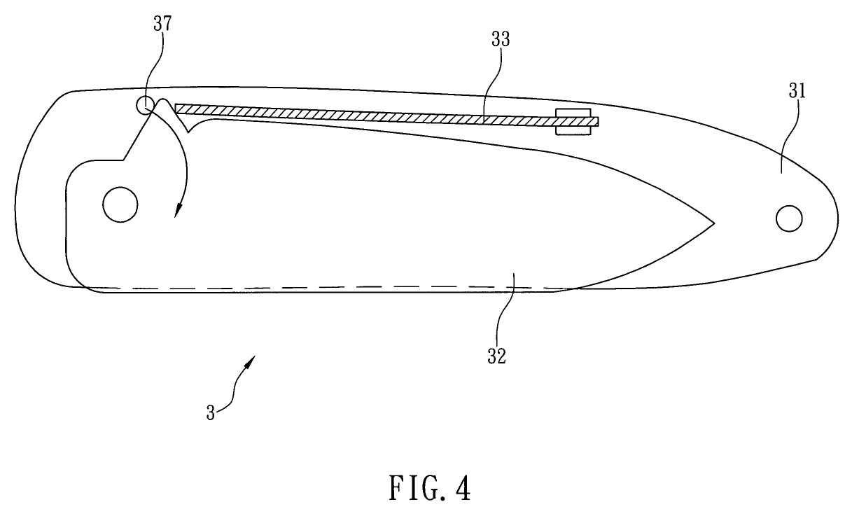

Referring to FIGS. 3 and 4 for a folding knife with a turning device installed on a knife handle in accordance with a first preferred embodiment of the present invention, FIG. 4 shows a cross-sectional view of a folding knife as depicted in FIG. 3 wherein the folding knife is folded. The folding knife 3 comprises a knife handle 31, a blade 32, a resilient device 33 and a turning device 34, wherein an end of the blade 32 is pivotally coupled to an end of the knife handle 31, so that the blade 32 can be turned along a pivotal connecting position into or out from the knife handle 31, and an end of the resilient device 33 is fixed to a position proximate to another end of the knife handle 31, and another end of the resilient device 33 is extended to a position proximate to a pivotal connecting position of the knife handle 31 and the blade 32, such that when the blade 32 is stored completely into the knife handle 31, the resilient device 33 produces a torque to turn the blade 32 into of the knife handle 31 to securely store the blade 32 in the knife handle 31, and when a force is applied to the blade 32 to turn the blade 32 to a predetermined angle out from the knife handle 31, the resilient device 33 produces a torque to turn the blade 32 out from the knife handle 31 to pop the blade 32 out of the knife handle 31, A slot 35 substantially in an arc shape is disposed on a surface of the knife handle 31 proximate to an end of the blade 32, and a first fixing slot 38 disposed on a surface of the knife handle 31 having the slot 35, and a second fixing slot 39 disposed on a surface of the turning device 34 proximate to the knife handle 31. The turning device 34 is pivotally coupled to a surface having the slot 35 of the knife handle 31. A spring 36 is installed between the turning device 34 and the knife handle 31 and both ends of the spring 36 are fixed to the first fixing slot 38 and the second fixing slot 39 respectively. The turning device 34 has a protruding pillar 37 disposed on a surface proximate to the knife handle 31 and passed through the slot 35 of the knife handle 31, such that when the blade 32 is stored completely into the knife handle 31, the protruding pillar 37 is pressed against the blade 32. When a user turns the turning device 34, the protruding pillar 37 applies a force to the blade 32, such that the blade 32 is turned to the predetermined angle out from the knife handle 31, and thus the resilience of the spring 36 resumes the turning device 34 to its original position.

In the aforementioned first preferred embodiment, if a user wants to use the folding knife 3 by holding the folded folding knife 3, the user must place the thumb gently on the turning device 34 to turn the turning device 34, such that the protruding pillar 37 applies a force to the blade 32 to turn the blade 32 to the predetermined angle out from the knife handle 31, and thus the resilient device 33 produces a torque to turn the blade 32 out from the knife handle 31, and the blade 32 pops automatically out from the knife handle 31. Therefore, even if the user simply operates the folding knife 3 by a hand, the user still can pop the blade 32 out easily from the knife handle 31 automatically to use the folding knife 3. After the blade 32 pops out automatically from the knife handle 31, the user simply needs to move the thumb gently on the turning device 34, and the turning device 34 can be resumed to its original position quickly and automatically by the resilience of the spring 36. Therefore, the user no longer needs to worry about returning the turning device 34 to its original position, and the invention improves the efficiency of use greatly.

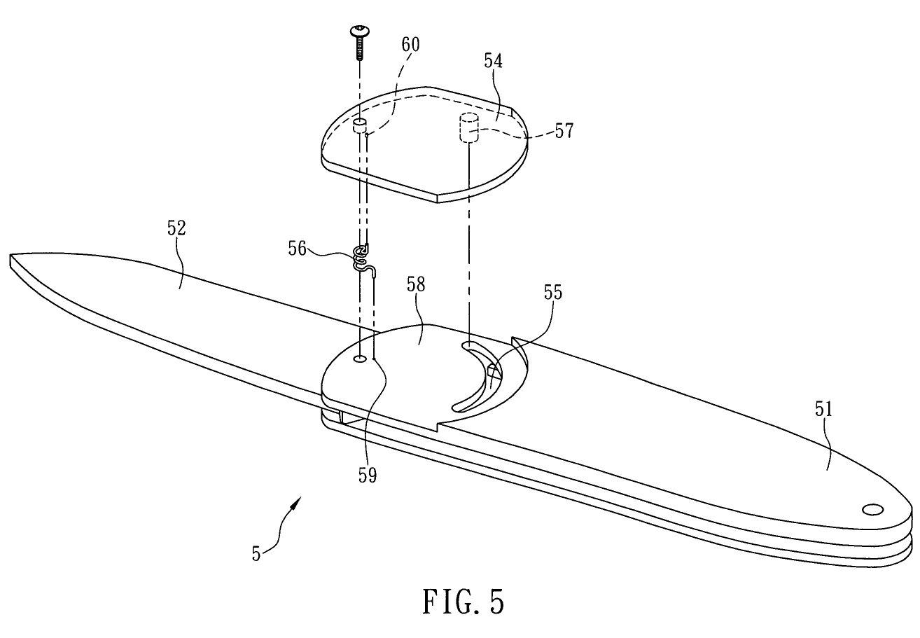

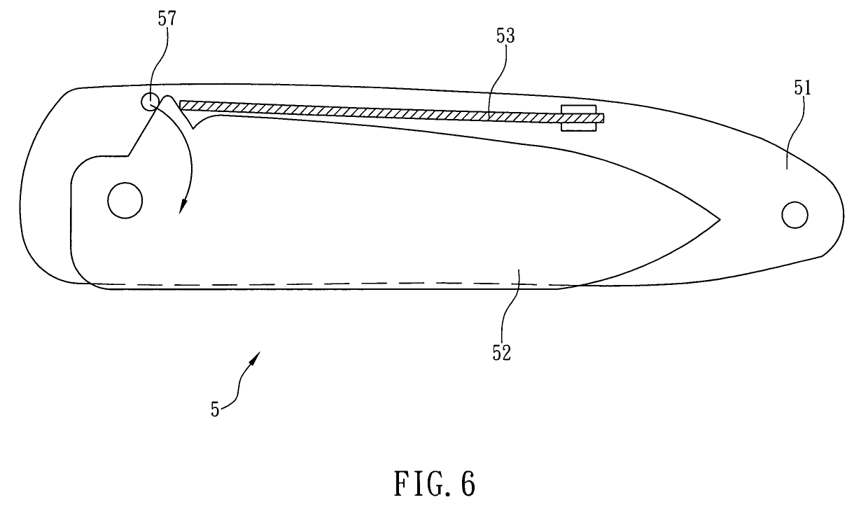

Referring to FIGS. 5 and 6 for a second preferred embodiment of the present invention, FIG. 6 shows a cross-sectional view of the folding knife as depicted in FIG. 5, and the folding knife 5 comprises a knife handle 51, a blade 52, a resilient device 53 and a turning device 54, wherein an end of the blade 52 is pivotally coupled to an end of the knife handle 51, such that the blade 52 can be turned along the pivotal connecting position into or out from the knife handle 51, and an end of the resilient device 53 is fixed to a position proximate to another end of the knife handle 51, and another end of the resilient device 53 is extended to a position proximate to a pivotal connecting position of the knife handle 51 and the blade 52. When the blade 52 is stored completely into the knife handle 51, the resilient device 53 produces a torque to the blade 52 to turn the blade into the knife handle 51, so that the blade 52 can be stored securely in the knife handle 51. A force can be applied to the blade 52 to turn the blade 52 to a predetermined angle out from the knife handle 51, so that the resilient device 53 produces a torque to turn the blade 52 out from the knife handle 51 to pop the blade 52 automatically out from the knife handle 51. The knife handle 51 has a concave surface 58 disposed proximate to an end of the blade 52, and the concave surface 58 has a slot 55 thereon, and the slot 55 is substantially in an arc shape. The concave surface 58 has a first fixing point 59, and the turning device 54 has a second fixing point 60, and the turning device 54 is pivotally coupled to a position on the concave surface 58 and proximate to the first fixing point 59. A spring 56 is installed at the pivotal connecting position of the turning device 54 and the concave surface 58, and both ends of the spring 56 are fixed to the first fixing point 59 and the second fixing point 60 respectively. The turning device 54 can be turned along the pivotal connecting position, and the turning device 54 and the knife handle 51 constitute an overall appearance. The turning device 54 has a protruding pillar 57 disposed on a surface proximate to the concave surface 58, and the protruding pillar 57 is passed through the slot 55 of the concave surface 58. When the blade 52 is stored completely into the knife handle 51, the protruding pillar 57 is pressed against the blade 52 to constitute the folding knife of this embodiment. The user simply needs to turn the turning device 54, such that the protruding pillar 57 applies a force to the blade 52 to turn the blade 52 to the predetermined angle out from the knife handle 51, and the resilient device 53 produces a torque to turn the blade 52 out from the knife handle 51, and the blade 52 can pop out automatically from the knife handle 51. Until the user releases the turning device 54, the turning device 54 resumes its original position by the resilience of the spring 56.

In the aforementioned second preferred embodiment, the user simply needs to use a hand to pop the blade 52 out from the knife handle 51 to make the application simple and easy. Since the turning device 54 is pivotally coupled to the concave surface 58, the turning device 54 and the knife handle 51 constitute the overall appearance of the folding knife, not only improving the aesthetic appearance greatly, but also facilitating users to store the folding knife 5 into a knife sheath properly. It is noteworthy to point out that the turning device 54 and the knife handle 51 constitute the whole folding knife, and thus even if the folding knife 5 is dropped onto the ground, the blade 52 will not pop out from the knife handle 52 when the turning device 54 hits the ground. Therefore, the invention not only effectively prevents the blade 52 from being damaged by the collision with the ground, but also protects the safety of the user and people nearby. When the user places the folding knife 5 in a pocket, the user needs not to worry about touching the turning device 54 by accident, and thus the invention can effectively prevent the blade 52 from popping out, damaging the user's clothes, or injuring the user. Obviously, the folding knife 5 concurrently achieves both convenience and safety of its use, and thus the invention can effectively overcome the shortcomings of the prior art.

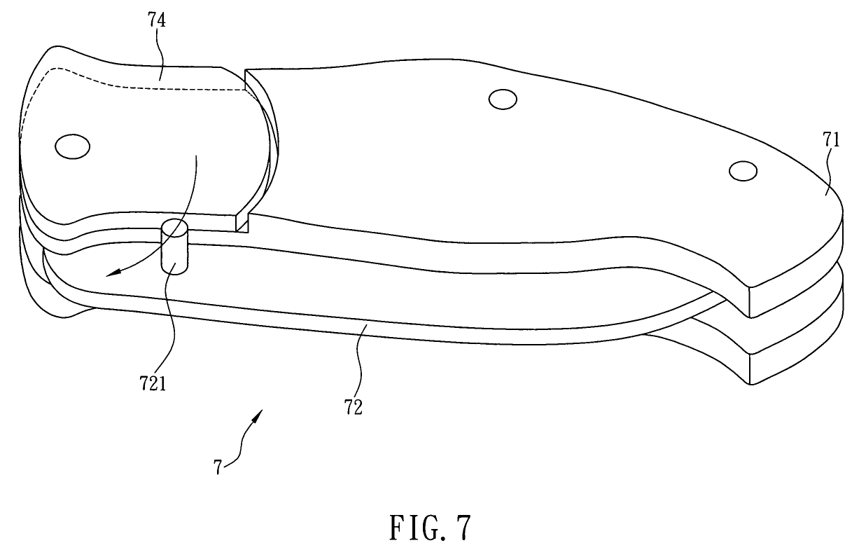

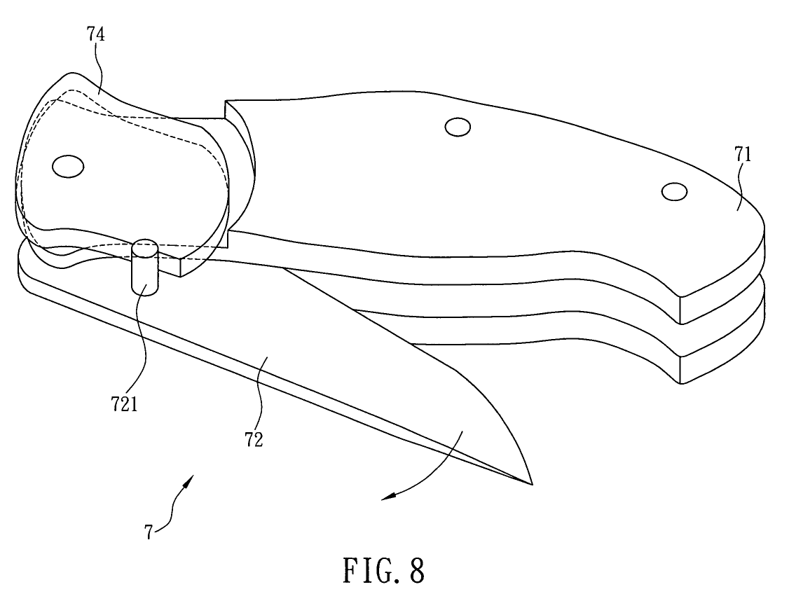

Referring to FIGS. 7 and 8 for a folding knife in accordance with a third preferred embodiment of the present invention, the folding knife 7 comprises a knife handle 71, a blade 72, a resilient device and a turning device 74, wherein an end of the blade 72 is pivotally coupled to an end of the knife handle 71, so that the blade 72 can be turned into or out from the knife handle 71 along a pivotal connecting position, and the blade 72 has a force exertion pillar 721 protruded from a position proximate to a side of the pivotal connecting position, and an end of the resilient device is fixed to a position proximate to another end of the knife handle 71, and another end of the resilient device is extended to a position proximate to the pivotal connecting position of the knife handle 71 and the blade 72, so that if the blade 72 is accommodated completely into the knife handle 71, the resilient device can produce a torque to turn the blade 72 towards the interior of the knife handle 71, and a force is applied to the blade 72 to turn the blade to a predetermined angle out from the knife handle 71, the resilient device can produce a torque to turn the blade 72 towards the exterior of the knife handle 71. A concave surface is disposed on the exterior of the knife handle 71 and at a position proximate to a side of the force exertion pillar 721, and the turning device 74 is pivotally coupled to the concave surface of the knife handle 71. If the turning device 74 is turned, the turning device 74 can apply a force to the force exertion pillar 721 to drive the blade 72 and turn the blade 72 to the predetermined angle out from the knife handle 71, so that the resilient device produces a torque to turn the blade 72 towards the exterior of the knife handle 71 and pop the blade 72 out from the knife handle 71 automatically. Therefore, users can hold the folding knife 7 by one hand, and turn the turning device 74 by a thumb to pop the blade 72 out for using the folding knife 7. The invention can greatly improve the convenience and safety of operating the folding knife.

In view of the description above, the invention is illustrated by several preferred embodiments, but the characteristics of the invention are not limited to such embodiments only. The turning device is pivotally coupled onto a pivotal connecting position of the blade and the knife handle, and the turning device is pivotally coupled to a position proximate to the pivotal connecting position of the blade and the knife handle. Regardless of the position to where the turning device is pivotally coupled, the turning device can be turned along the pivotal connecting position, and the protruding pillar can be passed through the slot.

While the invention has been described by means of specific embodiments, numerous modifications and variations could be made thereto by those skilled in the art without departing from the scope and spirit of the invention set forth in the claims.

What is claimed is:

1. A folding knife with a turning device on a knife handle, comprising:
a knife handle, having a slot disposed on a surface at an end of the knife handle;
a blade, with an end pivotally coupled to an end of the knife handle that has the slot, and the blade being turnable along a pivotal connecting position of the knife handle into or out from the knife handle;
a resilient device, with an end fixed to a position proximate to another end of the knife handle, and another end of the resilient device being extended to a position proximate to the pivotal connecting position, so that when the blade is stored completely into the knife handle, the resilient device produces a torque to turn the blade into the knife handle, and when the blade is turned to a predetermined angle out of the knife handle, the resilient device produces a torque to turn the blade out from the knife handle; and
a turning device, pivotally coupled to a surface of the knife handle having the slot, and including a protruding pillar disposed on a surface of the turning device and proximate to the knife handle, and the protruding pillar passing through the slot of the knife handle, such that when the blade is stored completely into the knife handle, the protruding pillar presses against the blade, and when the turning device is turned, the protruding pillar applies a force to turn the blade to the predetermined angle out of the knife handle, such that the resilient device can produce a torque to turn the blade out from the knife handle, and the blade can pop out from the knife handle automatically.

2. The folding knife of claim 1, further comprising a spring installed between the turning device and the knife handle, such that when the turning device is turned, the resilience of the spring resumes the turning device to its original position automatically.

3. The folding knife of claim 2, wherein the slot is in an arc shape.

4. The folding knife of claim 3, wherein the turning device is pivotally coupled to the pivotal connecting position of the blade and the knife handle.

5. The folding knife of claim 3, wherein the turning device is pivotally coupled to the pivotal connecting position of the blade and the knife handle and proximate to the knife handle.

6. The folding knife of claim 4, wherein the spring is installed at the pivotal connecting position of the blade and the knife handle.

7. The folding knife of claim 5, wherein the spring is installed at the pivotal connecting position of the blade and the knife handle.

8. The folding knife of claim 4, wherein the spring is installed proximate to the pivotal connecting position of the blade and the knife handle.

9. The folding knife of claim 5, wherein the spring is installed proximate to the pivotal connecting position of the blade and the knife handle.

10. The folding knife of claim 4, wherein the knife handle has a concave surface disposed thereon and proximate to an end of the blade, and the concave surface includes the slot, and the turning device is pivotally coupled to the concave surface of the knife handle, and the spring is installed between the turning device and the concave surface, such that the turning device can be turned along the pivotal connecting position, and the turning device and the knife handle constitute an overall aesthetic appearance of the folding knife.

11. The folding knife of claim 5, wherein the knife handle has a concave surface disposed thereon and proximate to an end of the blade, and the concave surface includes the slot, and the turning device is pivotally coupled to the concave surface of the knife handle, and the spring is installed between the turning device and the concave surface, such that the turning device can be turned along the pivotal connecting position, and the turning device and the knife handle constitute an overall aesthetic appearance of the folding knife.

12. A folding knife with a turning device on a knife handle, comprising:
a knife handle;
a blade, with an end pivotally coupled to an end of the knife handle, and the blade being turnable along a pivotal connecting position of the knife handle into or out from the knife handle, and the blade having a force exertion pillar protruded form a position proximate to a side of the pivotal connecting position;
a resilient device, with an end fixed to a position proximate to another end of the knife handle, and another end of the resilient device being extended to a position proximate to the pivotal connecting position of the knife handle and the blade, such that when the blade is accommodated completely into the knife handle, the resilient device can produce a torque to turn the blade towards the interior of the knife handle, and when a force is applied to the turn blade to a predetermined angle out from the knife handle, the resilient device can produce a torque to turn the blade towards the exterior of the knife handle; and
a turning device, pivotally coupled to an exterior of the knife handle and disposed proximate to a side of the force exertion pillar, such that if the turning device is turn, the turning device can apply a force to the force exertion pillar and drive the blade to turn to a predetermined angle out from the knife handle, such that the resilient device produces a torque to turn the blade towards the exterior of the knife handle to automatically pop the blade out from the knife handle.

13. The folding knife of claim 12, further comprising a spring installed between the turning device and the knife handle for automatically resuming the turned turning device to its original position by the resilience of the spring after the turning device is turned.

14. The folding knife of claim 13, wherein the turning device is pivotally coupled to a pivotal connecting position of the blade and the knife handle.

15. The folding knife of claim 13, wherein the turning device is pivotally coupled to the knife handle and disposed proximate to a pivotal connecting position of the blade and the knife handle.

16. The folding knife of claim 14, wherein the spring is installed at a pivotal connecting position of the blade and the knife handle.

17. The folding knife of claim 15, wherein the spring is installed at a pivotal connecting position of the blade and the knife handle.

18. The folding knife of claim 14, wherein the spring is installed at a position proximate to a pivotal connecting position of the blade and the knife handle.

19. The folding knife of claim 15, wherein the spring is installed at a position proximate to a pivotal connecting position of the blade and the knife handle.

20. The folding knife of claim 14, wherein the knife handle includes a concave surface disposed on a side of the force exertion pillar, and the turning device is pivotally coupled to the concave surface.

21. The folding knife of claim 15, wherein the knife handle includes a concave surface disposed on a side of the force exertion pillar, and the turning device is pivotally coupled to the concave surface.
